(19) United States
(12) Patent Application Publication
(10) Pub. No.: US 2009/0061198 A1
(43) Pub. Date: Mar. 5, 2009

(54) POLYESTER PADDING FOR GYMNASIUM

(76) Inventor: Surendra S. Khambete, West Bloomfield, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/033,187

(22) Filed: Feb. 19, 2008

Related U.S. Application Data
(60) Provisional application No. 60/969,741, filed on Sep. 4, 2007.

(51) Int. Cl. B32B 7/08; B32B 27/36; E04G 21/14; B32B 7/12

(52) U.S. Cl. 428/223; 428/480; 428/343; 52/747.1

(57) ABSTRACT

A method is disclosed for equipping a gymnasium with padded articles. The padded articles include non-woven, randomly oriented polyester fiber core blocks, floor mats and wall mats. In one example, the blocks are coated in a flexible material, such as flocking, rubber or a non-rubber elastomer, to prevent an exterior of the blocks from fraying. The mats also include a core of non-woven, randomly oriented polyester fibers that are wrapped in a durable, aesthetic covering. A scrim can be used to provide desired flammability characteristics, eliminating the need for toxic additives and flame retardants. The blocks can be washed and reused, and are fully recyclable.

This patent application claims priority to provisional application No. 60/969,741 filed Sep. 4, 2007.

### BACKGROUND

This disclosure relates to cushioning structures suitable for use in a gymnasium.

An example gymnasium 10 is shown in FIG. 1. A typical gymnasium 10 includes various structures that provide padding to cushion the fall of a gymnast. In one typical gymnasium 10, a tumble mat 14 is arranged on a floor 12, and a wall mat 16 is secured to a wall. The tumble and wall mats 14, 16 are typically constructed from polyurethane foam covered in a material such as vinyl, which is sewn about the foam.

A pit 18 is provided in the floor 12 of some gymnasiums and filled with loose blocks 20, which are constructed from bare, uncovered polyurethane foam. The pit 18 is arranged beneath equipment to cushion the fall of a gymnast. As a result, the foam blocks come into contact with the gymnasts, absorbing sweat and odors. However, the foam blocks cannot be easily cleaned. Additionally, the foam blocks break down over time and must be replaced since polyurethane foam is generally not recyclable, and typically land filled.

Flammability issues also make polyurethane foam undesirable. The Upholstered Furniture Action Council (UFAC) has developed a voluntary industry standard for many years but growing consumer activism and concerns about flammability has prompted more research and use of flame retardants and combustion modifiers. Typically, the combustion modifiers that are compatible with foam processing tend to produce undesirable softening and some degradation in performance requirements. New federal standards being proposed will further challenge existing standards. Although alternatives are being researched, dominant technology for combustion modifiers involves the use of halogenated compounds which are again not acceptable to regulatory and consumer activists. There is also a cost penalty associated with the use of flame retardants/combustion modifiers.

With the advent of regulatory pressure and standards like California Furniture Standards (Cal TB 117, Cal TB 133), Boston Fire Code, NY Port Authority code, Federal Aviation Authority (FAA) standards there is ongoing pressure to better conform to smoldering resistance and resistance to small open flame ignition. This requirement has substantially increased the use of combustion modifiers by the polyurethane foam industry. Alternatives to achieving desired results or passing certain specifications, such as UL 1975, have revolved around use of special fabrics or inter-liners and are limited to certain applications.

Other concerns regarding polyurethane foams and combustion modifiers remain that the new alternatives not present environmental problems equal or worse than the current situation. Polyurethane foams include additives as a combustion modifier, for example, which act as a fire retardant. The fire retardant additives only serve to raise the ignition point of the polyurethane foam. However, once the polyurethane foam is ignited, it burns with a very hot and intense flame. As a result, it is desirable to eliminate the use of polyurethane foams from spaces occupied by people. Furthermore, flame retardant additives are considered environmentally undesirable to some since it is a chemical that is absorbed into the human body. What is needed is a padding alternative to polyurethane foam for use in gymnasiums that is also hypoallergenic, washable, possibly anti-microbial and recyclable.

### SUMMARY

A method is disclosed for equipping a gymnasium with padded articles. The padded articles include non-woven, randomly oriented polyester fiber core blocks, floor mats and wall mats. In one example, the blocks are coated in a flexible material, such as flocking, rubber or a non-rubber elastomer, to prevent an exterior of the blocks from fraying. The mats also include a core of non-woven, randomly oriented polyester fibers that are wrapped in a durable, aesthetic covering. A scrim can be used to provide desired flammability characteristics, eliminating the need for bromine. The blocks can be washed and reused, and are fully recyclable.

These and other features of the disclosure can be best understood from the following specification and drawings, the following of which is a brief description.

### BRIEF DESCRIPTION OF THE DRAWINGS

FIG. 1 is a perspective view of an example gymnasium.

FIG. 2 is a perspective view of one example coated, polyester fiber block for a gymnasium.

FIG. 3 is a perspective view of another example coated, polyester fiber block for a gymnasium.

FIG. 4 is a perspective view of another example coated, polyester fiber block for a gymnasium.

FIG. 5 is a cross-sectional view of a polyester fiber mat for a gymnasium.

### DETAILED DESCRIPTION

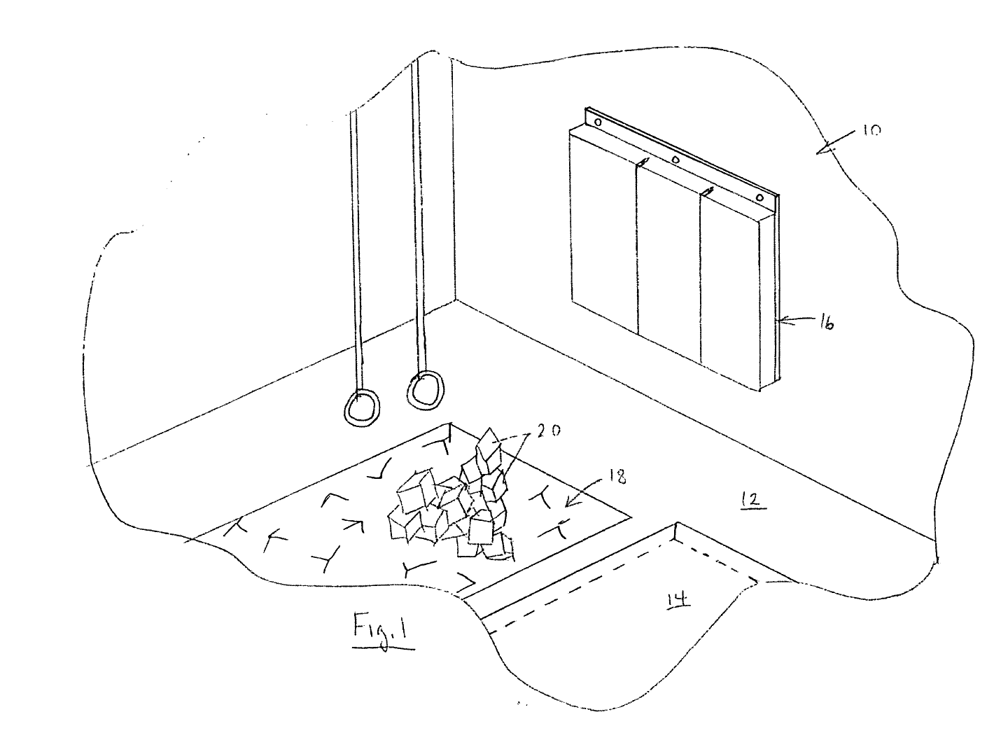

FIG. 1 schematically illustrates an example gymnasium. As described in the Background, a typical gymnasium uses polyurethane foam to provide padding to gymnasts. According to one example of the disclosure, the polyurethane foam typically used in padded structures within a gymnasium 10 is replaced with polyester. Polyester-based materials and blends provide a completely recyclable end product. The polyester is selected to have desired flammability properties.

The polyester material is provide by polyester fibers that may include a staple or matrix fiber along with some low and high melt binder fibers, which also may have elastomeric properties. The polyester fibers are randomly oriented, non-woven fibers that are melted with binder fibers during a manufacturing process to interlink the fibers. The interlinked fibers provide some structural rigidity and cushioning, as opposed to loose fibers, which do not retain their cushioning properties over time. The fibers and manufacturing process can be selected to provide cushioning properties similar to polyester foam, if desired.

Referring to FIGS. 2-4, several example polyester fiber blocks 120, 220, 320 are shown. The blocks 120, 220, 320 include a core 22 constructed from randomly oriented polyester fibers 24 interlinked to one another by a binder 25. The core 22 includes an exterior 26 that can become frayed or broken down from use, generating lint. If desired, the exterior 26 can be covered in a flexible coating 28 to create a more durable block.

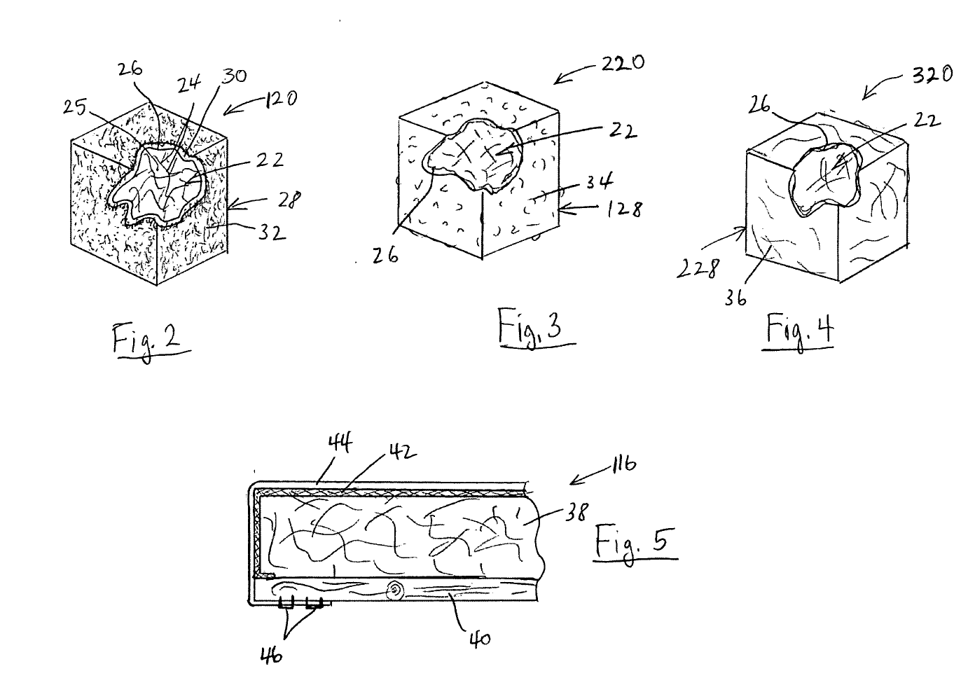

In one example shown in FIG. 2, the exterior 26 is sprayed in an adhesive material 30, and flocking material 32 is applied to the adhesive material 30. In this manner, the core 22 of the block 120 is prevented from fraying with use, and a soft-touch, aesthetic surface is provided. The exterior 26 of the block 220 can also be coated in a rubberized material 34, as shown in FIG. 3. Alternatively, an elastomeric, non-rubberized material 36 can be sprayed onto the exterior 26 of the block 320, as shown in FIG. 4. Other flexible coatings can also be adhered to the polyester fiber blocks.

Referring to FIG. 5, a gymnasium mat 116 is shown. The mat 116 includes a non-woven, randomly oriented polyester fiber core 38. The core 38 is wrapped in an aesthetic covering 44, such as a vinyl material, that is suitable for the application. The covering 44 is secured to a substrate 40, for example a wooden board, by fasteners 46, such as staples. The substrate 40 can be secured to a wall, as shown in FIG. 1. In the case of a floor mat, the core 38 may be wrapped entirely in the covering 44, which is sewn about the core, and the substrate 40 may be omitted. A scrim 42 can be used between the core 38 and the covering 44, if needed, to ensure that the mat 116 passes any applicable fire codes for its application. The scrim 42 is made from a rayon, moda-acrylic or carbonized polyester fiber material, for example.

The tumble and wall mats 14, 16, for example, can be manufactured in accordance with the apparatuses and methods set forth in Applicant's pending applications, for example, (U.S. Ser. No. 11/244,785, “Machine Having Variable Fiber Filling System for Forming Fiber Parts”; Ser. No. 11/246,609, “Cushion with Aesthetic Exterior”; Ser. No. 11/260,756, “Machine for Forming Fiber Parts”; Ser. No. 11/259,769, “Cushion with Aesthetic Exterior”; Ser. No. 11/261,354, “Machine for Forming Dual Density Fiber Parts”; Ser. No. 11/261,855, “Polyester Fiber Cushion Applications”; and Ser. No. 11/404,263, “Linear Process for Manufacture of Fiber Batts”), all of which are incorporated herein by reference. Of course, the blocks and mats can be constructed from other suitable methods as well. The blocks 120, 220 and 320 can be constructed from a polyester fiber batt that is cut into cubes using a hot wire, for example.

The non-woven, randomly oriented polyester fibers are bromine-free, which eliminates this undesired chemical from the padding while offering excellent flame resistance. The blocks do not require a covering so that the polyester can be exposed to the environment. However, the blocks 120, 220 and 320 are made more durable by incorporating a coating, which also provides an aesthetic covering with a desired feel.

The blocks can be washed periodically by the gymnasium or shredded and reformed into desired shapes by the manufacturer. Unlike polyurethane foam, the polyester cushions are completely recyclable and reusable.

Although example embodiments have been disclosed, a worker of ordinary skill in this art would recognize that certain modifications would come within the scope of the claims. For that reason, the following claims should be studied to determine their true scope and content.

What is claimed is:

1. A method of equipping a gymnasium with padded articles comprising the steps of:
providing randomly oriented, non-woven polyester fiber cores; and
arranging the cores in a desired location within a gymnasium to provide desired cushioning.

2. The method according to claim 1, wherein the providing step includes providing multiple individual blocks having the core, and the arranging step includes arranging the blocks in a pit within the gymnasium.

3. The method according to claim 2, wherein the providing step includes adhering a flexible coating onto an exterior of the cores.

4. The method according to claim 3, wherein the coating is at least one of a flocking material, a rubberized material and a non-rubberized elastomeric material.

5. The method according to claim 2, comprising the step removing the blocks from the pit, washing the blocks, and returning the washed blocks to the pit.

6. The method according to claim 2, comprising the step of removing the blocks from the pit, shredding the blocks, and forming the blocks into other polyester cushioned articles.

7. The method according to claim 1, wherein the providing step includes wrapping the core in an aesthetic covering to provide a mat, and the arranging step includes arranging the mat on one of a floor or a wall of the gymnasium.

8. A padded article for a gymnasium comprising:
a randomly oriented, non-woven polyester fiber core that includes an exterior, and
a flexible coating adhered to the exterior for preventing the exterior from fraying.

9. The padded article according to claim 8, wherein the coating includes a flocking material adhered to the exterior with an adhesive material.

10. The padded article according to claim 8, wherein the coating includes a rubberized material.

11. The padded article according to claim 8, wherein the coating includes a non-rubberized elastomeric material.

12. A padded article for a gymnasium comprising:
a randomly oriented, non-woven polyester fiber bromine-free core; and
an aesthetic covering provided about the core.

13. The padded article according to claim 12, comprising a scrim arranged between the covering and the core, the scrim including a desired flammability characteristic.

14. The padded article according to claim 12, comprising a substrate, the core supported on the substrate, and the aesthetic covering arranged over the core and secured to the substrate with fasteners.
